(19) United States
(12) Patent Application Publication
(10) Pub. No.: US 2017/0014979 A1
(43) Pub. Date: Jan. 19, 2017

(54) Tool Extension Bar

(71) Applicant: Hong Ann Tool Industries Co., Ltd., Taichung City (TW)

(72) Inventor: Cheng-Wei Su, Taichung City (TW)

(21) Appl. No.: 15/183,843

(22) Filed: Jun. 16, 2016

(30) Foreign Application Priority Data
Jul. 15, 2015 (TW) 104122923

(51) Int. Cl. B25B 23/00

(52) U.S. Cl. CPC B25B 23/0021

(57) ABSTRACT

A tool extension bar includes a first sleeve and a second sleeve connected with the first sleeve. The first sleeve includes a coupling hole extending therethrough, a radial hole interconnected with the coupling hole, and a first coupling portion. The second sleeve includes a through hole extending therethrough and interconnected with the coupling hole, and at least two flexible portions formed at one end thereof and extending along the through hole. Each flexible portion is configured to be flexibly bent and includes a second coupling portion engaged with the first coupling portion. An engaging member is movably received in the radial hole of the first sleeve. A rod is inserted through the coupling hole of the first sleeve and the through hole of the second sleeve. The rod includes a recess moveably engaged with the engaging member.

### BACKGROUND OF THE INVENTION

The present invention relates to a tool extension bar and, more particular, to a tool extension bar suitable to have an application with a power tool and adapted to be connected to or disconnected from a tool member, such as a socket.

U.S. Pat. No. 8,973,472 discloses a tool extension bar including a rod including first and second ends. The second end is adapted to connect to and be driven by a power tool. A sleeve assembly is slidably mounted around the rod and includes an end adapted for connecting to a tool member. A radial hole extends in a radial direction at an end of the sleeve assembly. An elastic member is mounted around the second end of the rod and is biased against the rod and the sleeve assembly. An engaging member is movably received in the radial hole and is moveably engaged in the recess of the rod. The engaging member releasably engages the sleeve with the rod.

In FIGS. 6 and 7 of the above-mentioned tool extension bar, an annular engaging portion is formed at the first end of the gripping member, and extends along the first axis toward the second end of the sleeve member. An annular engaging recess is formed at the second end of the sleeve member and is engaged with the engaging portion of the gripping member to cause the gripping member and the sleeve member to rotatable connect with each other.

However, the assembler has to spend a certain amount of time assembling the annular engaging portion of the gripping member into the annular engaging recess of the sleeve member.

The present invention is, therefore, intended to obviate or at least alleviate the problems encountered in the prior art.

### BRIEF SUMMARY OF THE INVENTION

The present invention solves this need and other problems in the field of extension bars by providing a tool extension bar including a first sleeve, a second sleeve connected with the first sleeve, an engaging member, and a rod. The first sleeve includes a coupling hole extending therethrough, a radial hole interconnected with the coupling hole, and a first coupling portion. The second sleeve includes a through hole extending therethrough and interconnected with the coupling hole, and at least two flexible portions formed at one end thereof and extending along the through hole. Each flexible portion is configured to be flexibly bent and including a second coupling portion engaged with the first coupling portion. The engaging member is movably received in the radial hole of the first sleeve. The rod is inserted through the coupling hole of the first sleeve and the through hole of the second sleeve. The rod includes a recess moveably engaged with the engaging member.

The first coupling portion is formed around an inner periphery of the coupling hole. The flexible portions are rotatably engaged with the first coupling portion. The second sleeve is rotatable in relation to the first sleeve and the rod.

In an example, the second sleeve includes six flexible portions circumferentially arranged around a periphery thereof in equal intervals. Each two adjacent flexible portions form a gap. Each second coupling portion is flexibly bent to be formed a hooked end radially extending opposite to the through hole. The coupling hole is circular. The first coupling portion is a circular groove, and the hooked end of each second coupling portion is arc shaped corresponding to the first coupling portion.

The tool extension bar further includes a biasing member arranged into the coupling hole of the first sleeve and located around the rod. The biasing member is configured to bias against the first sleeve and the rod.

The coupling hole includes a first section interconnected with the radial hole, and a second section located between the first section and the first coupling portion. The rod includes a body portion slidably inserted into the through hole of the second sleeve, and an abutting portion having a first end and a second end. The first end of the abutting portion forms the recess and is slidably inserted through the first section of the coupling hole. The second end of the abutting portion is located between the body portion and the first end and is slidably inserted through the second section of the coupling hole. The biasing member is arranged into the second section of the coupling hole and is located around an outer periphery of the first end of the abutting portion.

In an example, a first abutting face is formed between the first section and the second section of the coupling hole, and a second abutting face is formed between the first end and the second end of the abutting portion. The biasing member biases against the first abutting face and the second abutting face.

The first section of the coupling hole has a circular cross section with a diameter. The first end of the abutting portion has a circular cross section corresponding to the first section of the coupling hole. The second section of the coupling hole has four first faces formed around an outer edge thereof, and each two adjacent first faces is perpendicular to each other. Each two opposite first faces form a distance therebetween, and the distance is greater than the diameter. The second end of the abutting portion has four second faces formed around an outer edge thereof, and each second face is slidably abutted against each respective first faces.

In another example, the rod includes a driving portion integrally formed at an end of the body portion opposite to the abutting portion and perpendicular to the body portion.

A biasing member is arranged into the through hole of the second sleeve and is located around the rod. The biasing member is configured to bias against the first sleeve and the rod.

An end of through hole opposite to the flexible portions has a larger section. The rod includes a body portion and an assembling portion. The body portion is slidably inserted into the through hole of the second sleeve and is located between the recess and the assembling portion. The biasing member is arranged into the larger section of the through hole and is located around an end of the rod adjacent to the assembling portion. A first retaining face is formed at an end of the larger section adjacent to the flexible portions, and a second retaining face is formed between the body portion and the assembling portion. The biasing member biases against the first retaining face and the second retaining face.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a perspective view of a tool extension bar of a first embodiment according to the present invention.

FIG. 2 shows an exploded, perspective view of the tool extension bar of FIG. 1.

FIG. 3 shows a cross-section view of the tool extension bar of FIG. 1.

FIG. 4 shows a partial, enlarged view of FIG. 3.

FIG. 5 shows a continued, cross-section view of FIG. 4, and illustrates the second sleeve moved along an arrow.

FIG. 6 shows an exploded, perspective view of a tool extension bar of a second embodiment according to the present invention.

FIG. 7 shows a cross-section view of the tool extension bar of FIG. 6.

FIG. 8 shows a cross-section view of a tool extension bar of a third embodiment according to the present invention.

All figures are drawn for ease of explanation of the basic teachings only; the extensions of the figures with respect to number, position, relationship, and dimensions of the parts to form the illustrative embodiments will be explained or will be within the skill of the art after the following teachings have been read and understood. Further, the exact dimensions and dimensional proportions to conform to specific force, weight, strength, and similar requirements will likewise be within the skill of the art after the following teachings have been read and understood.

Where used in the various figures of the drawings, the same numerals designate the same or similar parts. Furthermore, when the terms “first”, “second”, “third”, “fourth”, “end”, “portion”, “longitudinal”, “radial”, “diameter”, “width”, “thickness”, and similar terms are used herein, it should be understood that these terms have reference only to the structure shown in the drawings as it would appear to a person viewing the drawings and are utilized only to facilitate describing the illustrative embodiments.

### DETAILED DESCRIPTION OF THE INVENTION

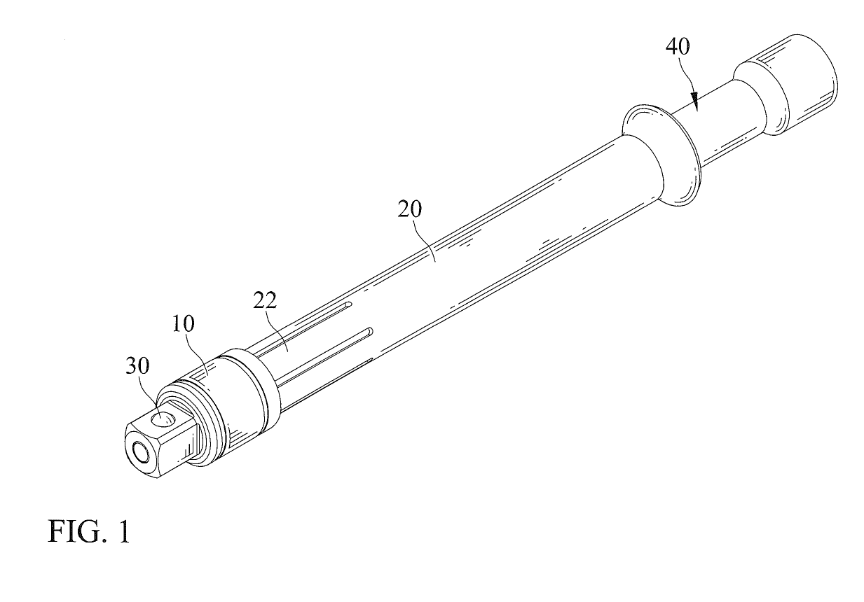

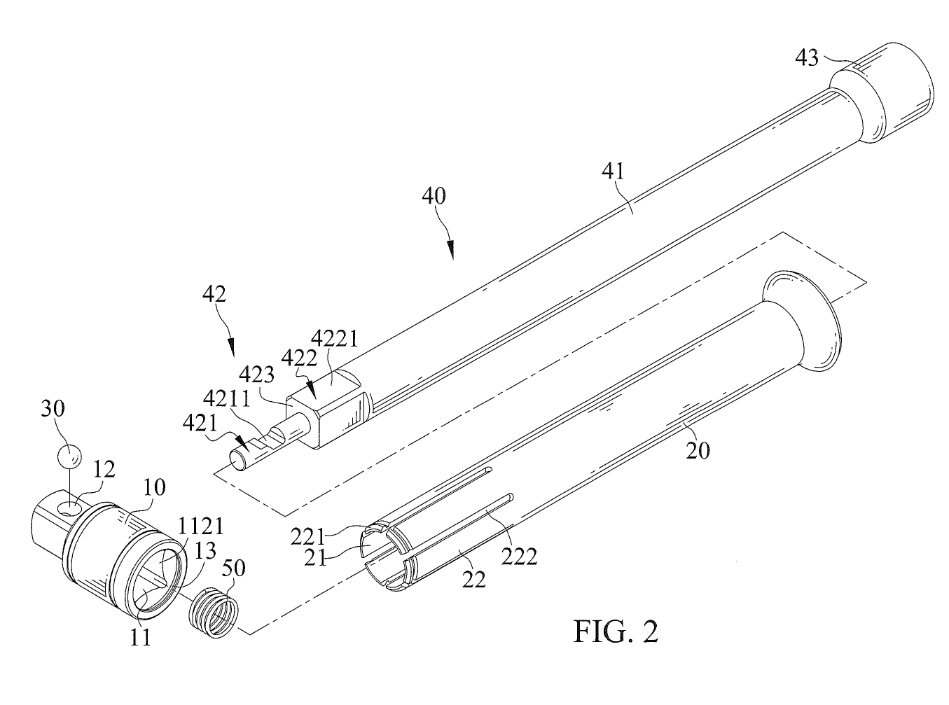

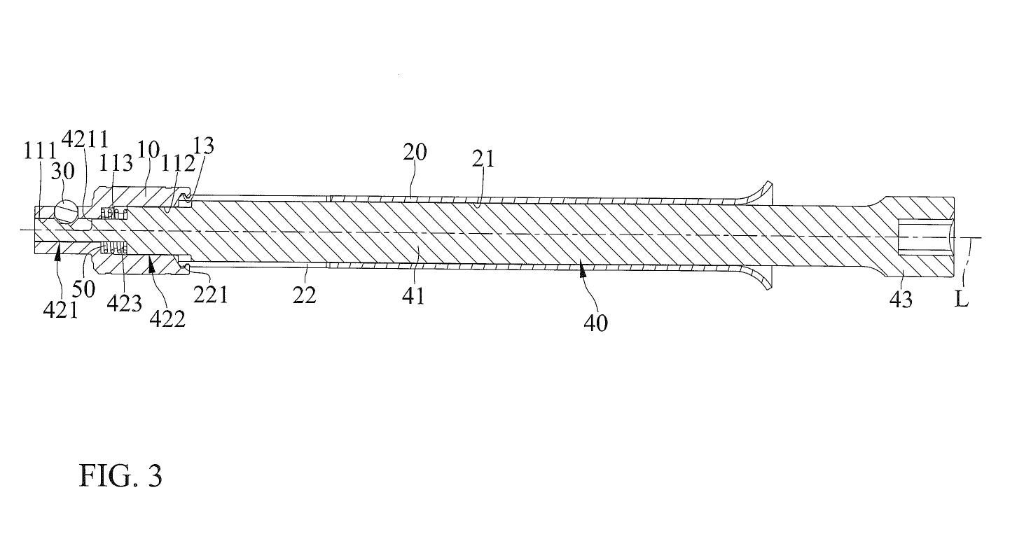

FIGS. 1-5 show a first embodiment of a tool extension bar according to the present invention shown in the drawings. The tool extension bar includes a first sleeve 10, a second sleeve 20 connected with the first sleeve 10, an engaging member 30 movably received in the first sleeve 10, and a rod 40 inserted through the first sleeve 10 and the second sleeve 20.

The first sleeve 10 is adapted for connecting to a tool member, such as a socket and is formed into a cylindrical shape extended along an axis L. The first sleeve 10 includes a coupling hole 11 extending therethrough along the axis L, a radial hole 12 interconnected with the coupling hole 11 and radially extending about the axis L, and a first coupling portion 13 formed around an inner periphery of the coupling hole 11. In the embodiment, the coupling hole 11 and the radial hole 12 both are circular, and the first coupling portion 13 is a circular groove.

The coupling hole 11 includes a first section 111 interconnected with the radial hole 12, a second section 112 located between the first section 111 and the first coupling portion 13, and a first abutting face 113 formed between the first section 111 and the second section 112 and perpendicular to the axis L. The first section 111 of the coupling hole 11 has a circular cross section, which is perpendicular to the axis L and has a diameter D1. The second section 112 has four first faces 1121 formed around an outer edge thereof and parallel to the axis L. Each two adjacent first faces 1121 is perpendicular to each other. Moreover, each two opposite first faces 1121 form a distance D2 therebetween. The distance D2 is greater than the diameter D1 to form the first abutting face 113. In the embodiment, each first faces 1121 is a rectangular face.

The second sleeve 20 is formed into a cylindrical shape extended along the axis L. The second sleeve 20 includes a through hole 21 extending therethrough along the axis L and interconnected with the coupling hole 11, and at least two flexible portions 22 formed at one end thereof and extending along the through hole 21. Each flexible portion 22 is parallel to the axis L and can be flexibly bent toward the axis L. Each flexible portion 22 includes a second coupling portion 221 rotatably engaged with the first coupling portion 13. Each second coupling portion 221 is bent to be formed a hooked end radially extending opposite to the through hole 21, and the hooked end of each second coupling portion 221 is arc shaped corresponding to the first coupling portion 13. Thus, the hooked end of each second coupling portion 221 is engaged with the first coupling portion 13 to cause the second sleeve 20 rotatable in relation to the first sleeve 10 and the rod 40. In the embodiment, the second sleeve 20 includes six flexible portions 22 circumferentially arranged around the periphery thereof in equal intervals, and each two adjacent flexible portions 22 forming a gap 222.

The engaging member 30 is movably received in the radial hole 12 of the first sleeve 10. In a preferred form, the engaging member 30 may be a ball engageable with the tool member to be selectively connected with the first sleeve 10.

The rod 40 is inserted through the coupling hole 11 of the first sleeve 10 and the through hole 21 of the second sleeve 20. The rod 40 includes a body portion 41, an abutting portion 42, and an assembling portion 43. The body portion 41 is slidably inserted into the through hole 21 of the second sleeve 20 and is located between the abutting portion 42 and the assembling portion 43. The abutting portion 42 has a first end 421, a second end 422, and a second abutting face 423. The first end 421 is slidably inserted through the first section 111 of the coupling hole 11. In the embodiment, the first end 421 has a circular cross section corresponding to the first section 111 of the coupling hole 11. The second end 422 is located between the body portion 41 and the first end 421 and is slidably inserted through the second section 112 of the coupling hole 11. The second abutting face 423 is formed between the first end 421 and the second end 422 and is perpendicular to the axis L. The second abutting face 423 is faced to the first abutting face 113. The assembling portion 43 is adapted to be connected to a pneumatic power tool.

The first end 421 is formed with a recess 4211 moveably engaged with the engaging member 30. The recess 4211 has a first contact section 4212 and a second contact section 4213. A first depth F1 is defined between the first contact section 4212 and an outer periphery of the first end 421. A second depth F2 is defined between the second contact section 4213 and the outer periphery of the first end 421. The second depth F2 is greater than the first depth F1. The engaging member 30 is moveably engaged in the first and second contact sections 4212 and 4213 of the recess 421 to cause the engaging member 30 movably received in the radial hole 12. The second end 422 has four second faces 4221 formed around an outer edge thereof and parallel to the axis L. Each second face 4221 is slidably abutted against each respective first faces 1121.

The tool extension bar further includes a biasing member 50 arranged into the second section 112 of the coupling hole 11 and is located around an outer periphery of the first end 421 of the abutting portion 42. The biasing member 50 is configured to bias against the first abutting face 113 of the first sleeve 10 and the second abutting face 423 of the rod 40. In the embodiment, the biasing member 50 may be a spring.

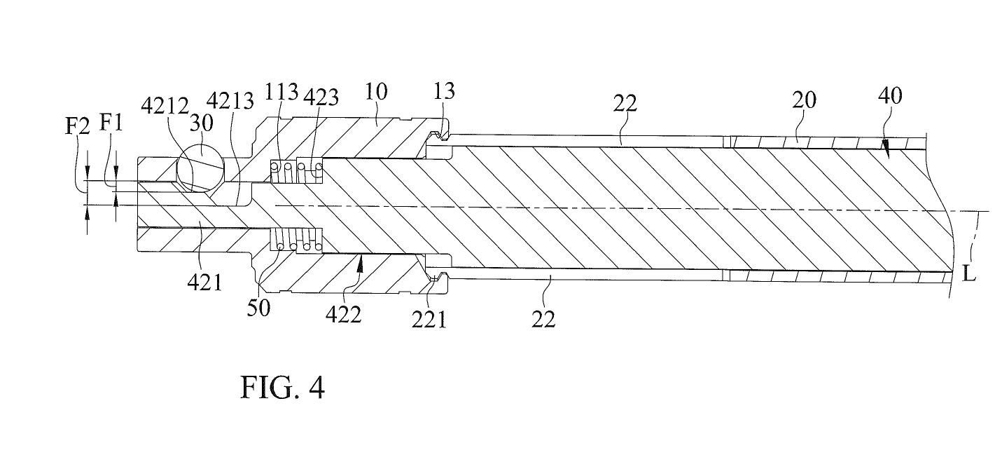

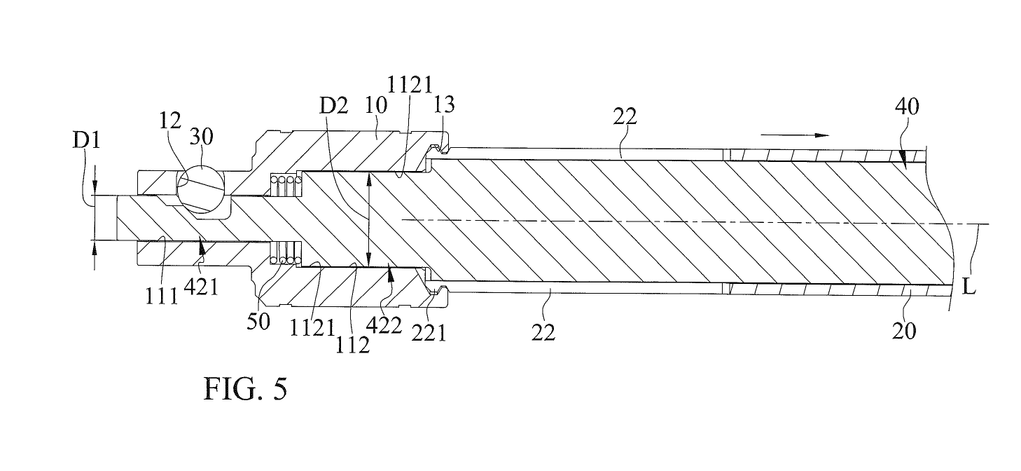

The second sleeve 20 is moveable relative to rod 40 along the axis L between a first position (shown in FIG. 4) and a second position (shown in FIG. 5). The biasing member 50 is compressed when the second sleeve 20 is in the second position. When the second sleeve 20 is moved to the first position, the engaging member 30 is pushed by the radial hole 12 of the first sleeve 10 and engaged in the first contact section 4212 of the recess 4211. As mentioned above, the first depth F1 in a radial direction perpendicular to the axis L less than the second depth F2. Thus, when the engaging member 30 is seated in the first contact section 4212, an outermost portion of the engaging member 30 extends out of the radial hole 12 to engage with the tool member. Therefore, the tool member is securely locked on the tool extension bar and can be driven when the rod 40 of the tool extension bar secured to power tool rotates.

When a user grips the second sleeve 20 and moves it along the axis L to cause the second sleeve 20 moved to the second position, the engaging member 30 is pushed by the radial hole 12 and is moved to engage in the second contact section 4213 of the recess 4211. As mentioned above, the outermost portion of the engaging member 30 does not extend out of the radial hole 12 and disengages from the tool member. Therefore, the tool member is quickly unlocked on the tool extension bar. The two opposite ends of the biasing member 50 are respectively compressed against the first abutting face 113 of the first sleeve 10 and the second abutting face 423 of the rod 40. Thus, when the user does not grip the second sleeve 20, the two opposite ends of the biasing member 50 are respectively extended against the first abutting face 113 of the first sleeve 10 and the second abutting face 423 of the rod 40 to cause the second sleeve 20 moved from the second position to the first position without strain.

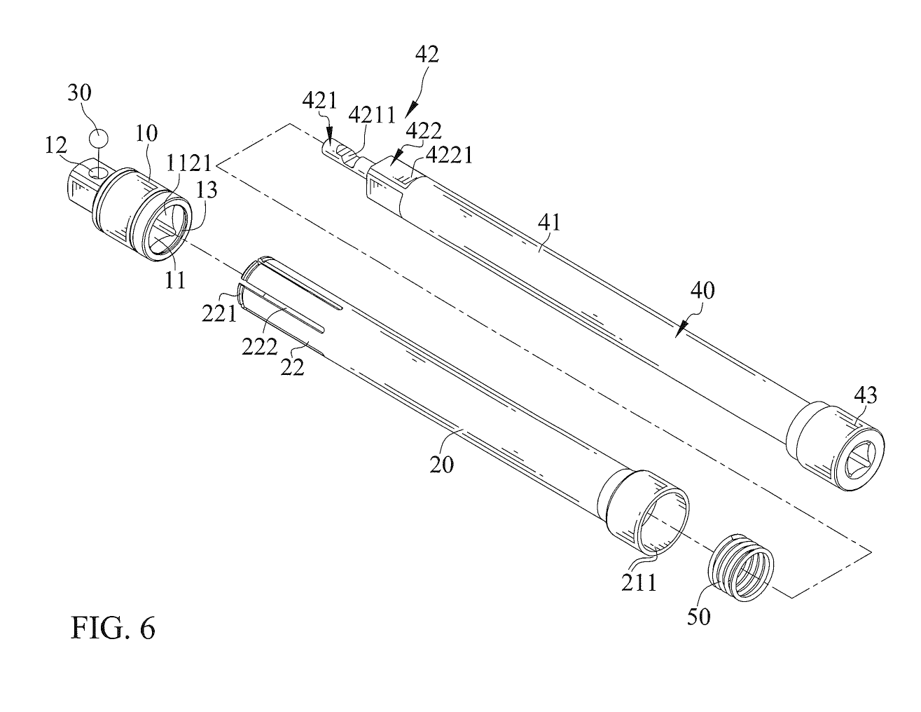

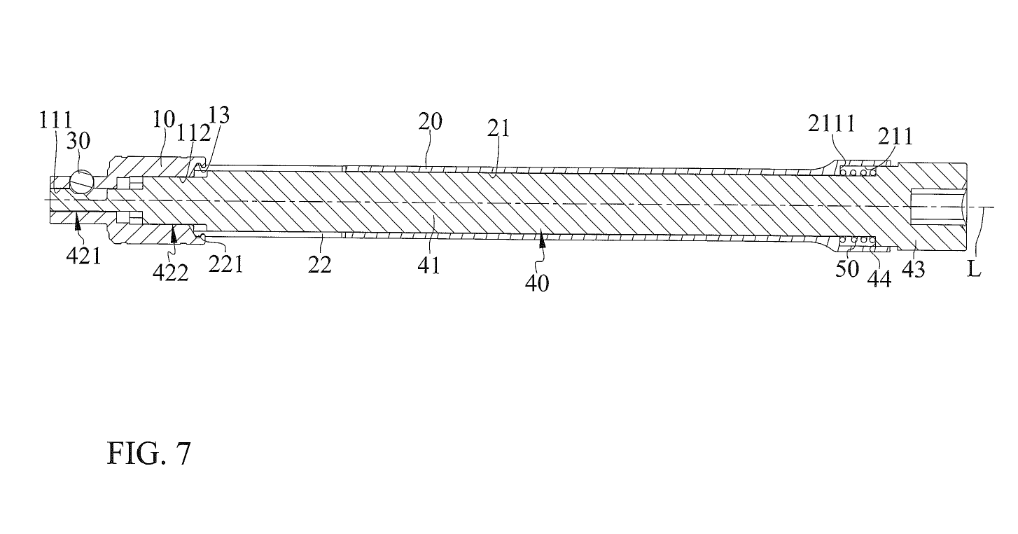

FIGS. 6 and 7 show a second embodiment of the tool extension bar according to the present invention shown in the drawings. Specifically, an end of through hole 21 opposite to the flexible portions 22 has a larger section 211. A first retaining face 2111 is formed at an end of the larger section 211 adjacent to the flexible portions 22 and is perpendicular to the axis L. A second retaining face 44 is formed between the body portion 41 and the assembling portion 43 and is perpendicular to the axis L. The biasing member 50 is arranged into the larger section 211 of the through hole 21 and is located around an end of the body portion 41 adjacent to the assembling portion 43. The biasing member 50 biases against the first retaining face 2111 and the second retaining face 43.

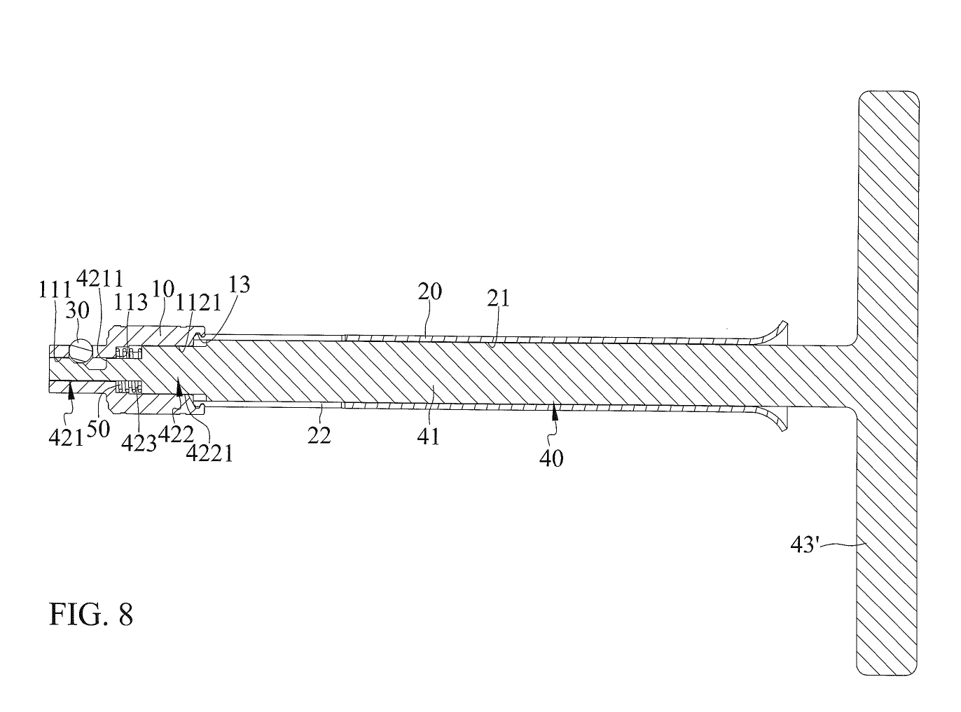

FIG. 8 shows a third embodiment of the tool extension bar according to the present invention shown in the drawings. Specifically, the rod 40 includes a driving portion 43′ integrally formed at an end of the body portion 41 opposite to the abutting portion 42 and perpendicular to the body portion 41. The user can rotate the driving portion 43′ to cause the second faces 4221 abut against the respective first faces 1121 for rotating the first sleeve 10.

In view of the foregoing, the present invention has the following advantages. When the second sleeve 20 is abutted against the first sleeve 10 for assembly, each flexible portion 22 is abutted against the first sleeve 10 and then is flexibly bent toward the axis L. Thus, each second coupling portion 221 can be easily engaged into the first coupling portion 13 to be greatly shorten the assembly time.

Thus since the illustrative embodiments disclosed herein may be embodied in other specific forms without departing from the spirit or general characteristics thereof, some of which forms have been indicated, the embodiments described herein are to be considered in all respects illustrative and not restrictive. The scope is to be indicated by the appended claims, rather than by the foregoing description, and all changes which come within the meaning and range of equivalency of the claims are intended to be embraced therein.

1. A tool extension bar comprising:
a first sleeve including a coupling hole extending therethrough, a radial hole interconnected with the coupling hole, and a first coupling portion;
a second sleeve connected with the first sleeve, with the second sleeve including a through hole extending therethrough and interconnected with the coupling hole, and at least two flexible portions formed at one end thereof and extending along the through hole, with each flexible portion configured to be flexibly bent and including a second coupling portion engaged with the first coupling portion;
an engaging member movably received in the radial hole of the first sleeve; and
a rod inserted through the coupling hole of the first sleeve and the through hole of the second sleeve, with the rod including a recess moveably engaged with the engaging member.

2. The tool extension bar as claimed in claim 1, with the first coupling portion formed around an inner periphery of the coupling hole, with the flexible portions rotatably engaged with the first coupling portion, and with the second sleeve rotatable in relation to the first sleeve and the rod.

3. The tool extension bar as claimed in claim 2, with the second sleeve including six flexible portions circumferentially arranged around the periphery thereof in equal intervals, with each two adjacent flexible portions forming a gap, with each second coupling portion flexibly bent to be formed a hooked end radially extending opposite to the through hole, with the coupling hole being circular, with the first coupling portion being a circular groove, and with the hooked end of each second coupling portion being arc shaped corresponding to the first coupling portion.

4. The tool extension bar as claimed in claim 3, further comprising:
a biasing member arranged into the coupling hole of the first sleeve and located around the rod, and with the biasing member configured to bias against the first sleeve and the rod.

5. The tool extension bar as claimed in claim 4, with the coupling hole including a first section interconnected with the radial hole, and a second section located between the first section and the first coupling portion, with the rod including a body portion slidably inserted into the through hole of the second sleeve, and an abutting portion having a first end and a second end, with the first end of the abutting portion forming the recess and slidably inserted through the first section of the coupling hole, with the second end of the abutting portion located between the body portion and the first end and slidably inserted through the second section of the coupling hole, and with the biasing member arranged into the second section of the coupling hole and located around an outer periphery of the first end of the abutting portion.

6. The tool extension bar as claimed in claim 5, with a first abutting face formed between the first section and the second section of the coupling hole, a second abutting face formed between the first end and the second end of the abutting portion, and with the biasing member biasing against the first abutting face and the second abutting face.

7. The tool extension bar as claimed in claim 5, with the first section of the coupling hole having a circular cross section with a diameter, with the first end of the abutting portion having a circular cross section corresponding to the first section of the coupling hole, with the second section of the coupling hole having four first faces formed around an outer edge thereof, with each two adjacent first faces perpendicular to each other, with each two opposite first faces forming a distance therebetween, with the distance greater than the diameter, with the second end of the abutting portion having four second faces formed around an outer edge thereof, and with each second face slidably abutted against each respective first faces.

8. The tool extension bar as claimed in claim 5, with the rod including a driving portion integrally formed at an end of the body portion opposite to the abutting portion and perpendicular to the body portion.

9. The tool extension bar as claimed in claim 1, further comprising:
a biasing member arranged into the through hole of the second sleeve and located around the rod, and with the biasing member configured to bias against the first sleeve and the rod.

10. The tool extension bar as claimed in claim 9, with an end of through hole opposite to the flexible portions having a larger section, with the rod including a body portion and an assembling portion, with the body portion slidably inserted into the through hole of the second sleeve and located between the recess and the assembling portion, with the biasing member arranged into the larger section of the through hole and located around an end of the rod adjacent to the assembling portion, with a first retaining face formed at an end of the larger section adjacent to the flexible portions, with a second retaining face formed between the body portion and the assembling portion, and with the biasing member biasing against the first retaining face and the second retaining face.
